(19) United States
(12) Patent Application Publication
(10) Pub. No.: US 2007/0043858 A1
(43) Pub. Date: Feb. 22, 2007

(54) WORM DETECTION METHOD AND APPARATUS USING ARP PACKET

(76) Inventor: Chae Hyun LEE, Ulsan (KR)

Correspondence Address: IPLA P.A., 3580 WILSHIRE BLVD., 17TH FLOOR, LOS ANGELES, CA, 90010, US

(21) Appl. No.: 11/465,391

(22) Filed: Aug. 17, 2006

(30) Foreign Application Priority Data
Aug. 22, 2005 (KR) 10-2005-0076743

(51) Int. Cl. G06F 15/173

(52) U.S. Cl. 709/224

(57) ABSTRACT

A worm detection method and apparatus using an ARP packet are disclosed. The worm detection method and apparatus using an ARP packet according to the present invention can be easily implemented, and the driving load of program is less. Since a common characteristic of worm is used, it is possible to easily detect and remove all types of worms with only one time execution on a common computer.

### FOREIGN PRIORITY CLAIMING

Applicant claims foreign priority under Paris Convention and 35 U.S.C. §119 to a Korean Patent Application No. 10-2005-0076743, filed Aug. 22, 2005 with the Korean Intellectual Property Office.

### TECHNICAL FIELD

The present invention relates to a worm detection method and apparatus using an ARP packet.

### BACKGROUND ART

A conventional method for detecting a worm comprises a pattern matching method, and a TRW (Threshold Random Walk) method. In the pattern matching method, a signature is searched from a packet transmitted by a worm. A host, which transmits a packet containing the above pattern, is recognized as a worm. This method has an advantage that it is possible to more reliably search a worm. However, this method is basically directed to detecting only the known worms. In the TRW method, it is checked that a certain number of worms fails accessing a TCP (Transmission Control Protocol). When the number of failures exceeds a certain number, it is recognized as a worm. This method is simple for implementation. However, it is impossible to detect a UDP (User Datagram Protocol). In the DWP method, the frequency of uses of a certain host computer is analyzed at each port. When the frequency of uses abnormally increases at a certain port, the port is recognized as a path for spreading worms, and the host, which continuously transmits the packet through the above port, is recognized as a worm. When the number of users sharply increases like a web server, it is impossible to recognize an ordinary user and a worm.

The above-described conventional worm detection methods have many problems as compared to less advantage. New worm detection method and apparatus are urgently needed for overcoming the above problems.

### DISCLOSURE OF THE INVENTION

Accordingly, it is an object of the present invention to provide a worm detection method and apparatus which overcome the problems encountered in the conventional art.

To achieve the above objects, in a method for detecting a worm-infected computer among multiple computers connected through a certain communication network, there is provided a worm detection method using an ARP packet which comprises a step (a) which receives an ARP packet from the communication network; a step (b) which extracts information concerning a transmission time of the received ARP packet, a transmission computer which transmits the packet, and a destination computer to which the packet is transmitted and stores the information with respect to the transmission computer; a step (c) in which a certain weight is given to the transmission computer in accordance with a certain reference based on a time interval at which the transmission computer transmits an ARP packet; a step (d) in which a certain weight is given to the transmission computer in accordance with a certain reference based on the number of the destination computers to which the transmission computer transmits the ARP packet; and a step (e) in which the transmission computer is recognized as being infected with a worm when a weight of the transmission computer exceeds a previously set certain reference value.

The worm detection method using an ARP packet further comprises a step (f) which disconnects a communication of the computer infected with worms.

According to the worm detection method using an ARP packet, in the step (c), an information concerning an ARP packet transmitted by the transmission computer is read out, and a weight is determined based on “(60−ARP packet transmission time interval)/10” when there are ARP packets which are transmitted within recent 60 seconds. In the step (e), the number of the destination computers of the ARP packets transmitted by the transmission computer is read out, and a weight is determined by summing a result value of “number of destination computers/20+1”. In the step (e), when the destination computer is duplicate in the number of the destination computers of the ARP packets transmitted by the transmission computer, the number of the destination computers is determined by excluding the duplicate number from the number of the destination computers.

The worm detection method using an ARP packet further comprises a step (g) which initializes the value of the weight with a certain time interval.

To achieve the above objects, in an apparatus for detecting a worm-infected computer among multiple computers connected through a certain communication network, there is provided a worm detection apparatus using an ARP packet which comprises an ARP packet receiver which receives an ARP packet from the communication network; an ARP packet analyzer which receives an ARP packet from the ARP packet receiver, extracts information concerning a transmission time of the received ARP packet, a transmission computer which transmits the packet, and a destination computer to which the packet is transmitted and stores with respect to the transmission computers; a time-based weight provision unit which receives an information concerning a time interval, at which the transmission computer transmits an ARP packet, from the ARP packet analyzer and provides a certain weight to the transmission computer in accordance with a certain reference based on the time interval; a destination-based weight provision unit which receives the number of the destination computers, to which the transmission computer transmits the ARP packet, from the ARP packet analyzer and provides a certain weight to the transmission computer in accordance with a certain reference based on the above number; and a worm judgment unit which receives a weight of the transmission computer from the time-based weight provision unit and the destination-based weight provision unit and recognizes the transmission computer as being infected with a worm when the weight of the transmission computer exceeds a previously set reference value.

The worm detection apparatus using an ARP packet further comprises a communication disconnection unit which receives an information concerning the worm-infected transmission computer from the worm judgment unit and disconnects a communication of the worm-infected transmission computer.

In the worm detection apparatus using an ARP packet, the time-based weight provision unit sets a result of “(60−ARP packet transmission time interval)/10” as a weight when the transmission computer transmits an ARP packet within recent 60 seconds by judging whether the transmission computer transmits the same or not. The destination-based weight provision unit sets a result of “the number of destination computers of the ARP packets transmitted from the transmission computer/20+1” as a weight. The destination-based weight provision unit determines the number of the destination computers by excluding the duplicate number from the number of the destination computers, when the destination of the ARP packet transmitted by the transmission computer is duplicate.

The worm detection apparatus using an ARP packet further comprises an initialization unit which initializes a value of the weight with a certain time interval.

### BRIEF DESCRIPTION OF THE DRAWINGS

The present invention will become better understood with reference to the accompanying drawings which are given only by way of illustration and thus are not limitative of the present invention, wherein;

FIG. 1 is a flow chart of a worm detection method using an ARP packet according to a preferred embodiment of the present invention; and

FIG. 2 is a block diagram illustrating a worm detection apparatus using an ARP packet according to a preferred embodiment of the present invention.

### MODES FOR CARRYING OUT THE INVENTION

The term “worm” used in the descriptions of the present invention is referred to a program which is capable of duplicating itself and moving the same to another computer through the network.

The principle of the present invention will be described as follows.

The worm is basically designed to transfer many packets to other computers so as to infect itself to others. However, the worm does not have information on the network, the worm is designed to transmit worm packets while fixing a C-class band or a B-class band and then uniformly changing the remaining bands.

For reference, a network address is classified into a 32-bit network name and a 32-bit subnet mask. Here, the network name is formed of ClassFull type A, B and C. In each range of the same, the A-class has an address range of 0.0.0.0-127.255.255.255 and a subnet mask of 200.0.0, and the B-class has an address range of 128.0.0.0-191.255.255.255 and a subnet mask of 255.255.0.0, and the C-class has an address range of 192.0.0.0-223.255.255.255 and a subnet mask of 255.255.255.0.

So, the connections are tried by the worms with respect to an IP (Internet Protocol) which is not used by the network and an IP address of the computer which is turned off. Namely, the computers, which have the above connections, may be recognized as a computer infected with the worms.

In the present invention, the ARP (Address Resolution Protocol) packet is used so as to analyze the above trials of connection. The ARP packet has been generally used so as to search a MAC (Media Access Control) address of the host when the IP of a certain host computer is known under the Ethernet environment. Since the host computer commonly has cash information like an ARP table, the host computer does not frequently transmit the ARP packet. Since the ARP is performed in a broadcasting method in which an arriving address is 255.255.255.255, when it is on the network, it is possible to know who transmits a certain ARP packet. When a certain host computer requests an ARP packet with respect to a certain IP, it means that a new connection is requested to the host computer.

Since the ARP packet is a normal packet, which may be used by a worm-infected host computer as well as a common communication, it is impossible to say that a corresponding host computer is infected with the worms when it transmits many ARP packets. In the present invention, it is possible to judge that a certain host computer is infected or not infected based on a result of the total scores, which are obtained by providing the computers with scores (weights), with the computers transmitting ARP packets.

The above weight has two types. Namely, there are a time-based weight which is given based on a process that how many ARP packets are transmitted to a host computer (destination computer) for a certain short time period, and a destination-based weight which is given based on a process that the ARP packets are transmitted to how many host computers for a unit time period.

The time-based weight will be described. For example, when there is a record that ARP packets are transmitted within 60 seconds, the time-based weight is “(60−time interval needed for the transmission of ARP packets)/10”. According to the above reference, the weight given to the host computer, which continuously transmits ARP packets at an interval of 40 seconds, is 2, and the weight given to the host computer, which continuously transmits ARP packets at an interval of 10 seconds, is 5. When the time interval exceeds 60 seconds, the weight is 0.

The above 60-second reference may be adjusted with other time intervals.

The destination reference weight is determined based on a process that a certain host computer transmits ARP packets to how many other host computers.

Namely, the destination reference weight is “number of destination computers/20+1”. Here, when the value of “number of destination computers/20+1” is less than 1, the value of the destination reference weight is 0.

For example, when the number of the destination computers is 0-19, the value of the destination reference weight is 0, and in the case of 80, the weight is 5.

There may be an occasion that multiple ARP packets are transmitted within a short time period with respect to one host computer. This occasion occurs when in a state that a normal host computer is turned off, other normal host computers continuously try connections. Since the worms are generally designed to try connections to multiple host computers within short time periods, it is preferred that the transmission of the ARP packets having duplicate destinations within a certain reference time period with respect to the same addresses is excluded from the number of the destination computers.

With the above-described references, the time-based weight and destination-based weight are computed with respect to the computers (IP) which transmit the ARP packets. When the sum of the weights exceeds a certain reference value (for example, 80), it is recognized that the above computer is infected with worms.

It is preferred that the value of the above weight is initialized to 0 at certain time interval, for example, 5 minutes.

In the case of a fully busy network, since it has cash information with respect to all IPs, even the host computer infected with worms may not transmit the ARP packets. In this case, a few IP bands are empted, and the weights are computed with respect to the host computers which try connections with respect to the above IPs, so that it is possible to detect the worms.

The preferred embodiments of the present invention will be described with reference to the accompanying drawings.

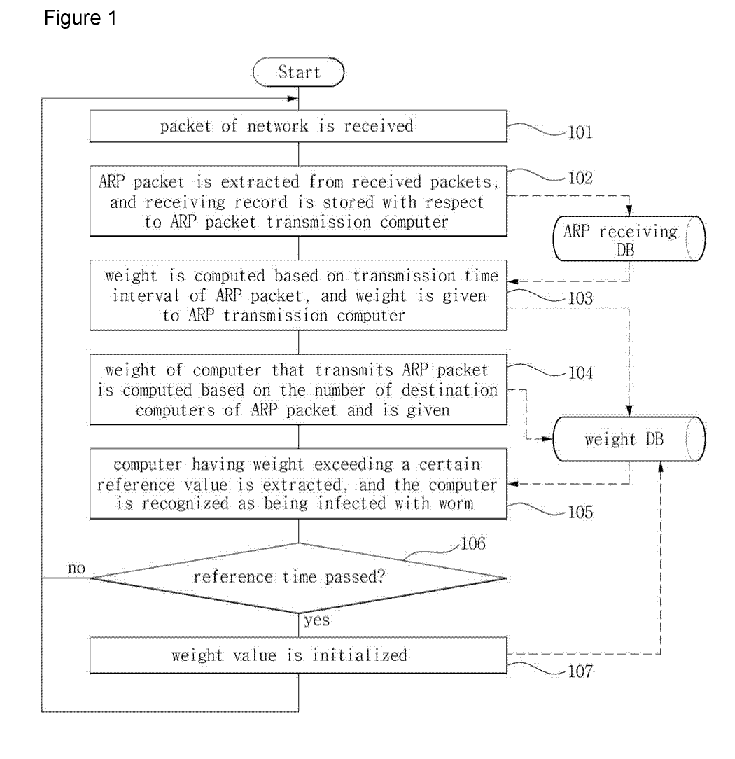

FIG. 1 is a flow chart of a worm detection method using an ARP packet according to the present invention.

A packet on a certain network is received in a step S101. An ARP packet is extracted from the above packet, and information concerning a transmission time of an ARP packet, a transmission computer (IP), and a destination computer (IP) of the above ARP packet is extracted and stored in a corresponding computer in a step S102.

The transmission time intervals of the ARP packets are read out with respect to the transmission computers. The time reference weights are computed based on the read-out data, and the weights are given to the transmission computers in a step S103.

The number of the destination computers of the ARP packets, which are transmitted within time period, is read out with respect to the transmission computers, and the destination reference weights are computed based on the read-out data, and the weights are given to the transmission computers in a step S104. So, it is possible to compute the number of the destination computers having the same destinations of the host computers within the above time period with the ARP packets having the duplicate destinations being excluded.

The time-based weight and the destination-based weight are computed with respect to the transmission computers. When the computed weights exceed a certain set reference value, it is recognized that the computer is infected with worms in a step S105, and the communication of the computer infected with the worms is disconnected (not shown in the drawings).

In the method for disconnecting the communication of the computer infected with worms, there is provided a switch of a communication network with respect to each transmission computer, so that the switch of the communication network of the computed infected with worms is turned off.

It is judged whether a certain reference time period is passed or not in a step S106. When the certain reference time period is passed, the weights given to the above transmission computer are initialized to 0 in a step S107.

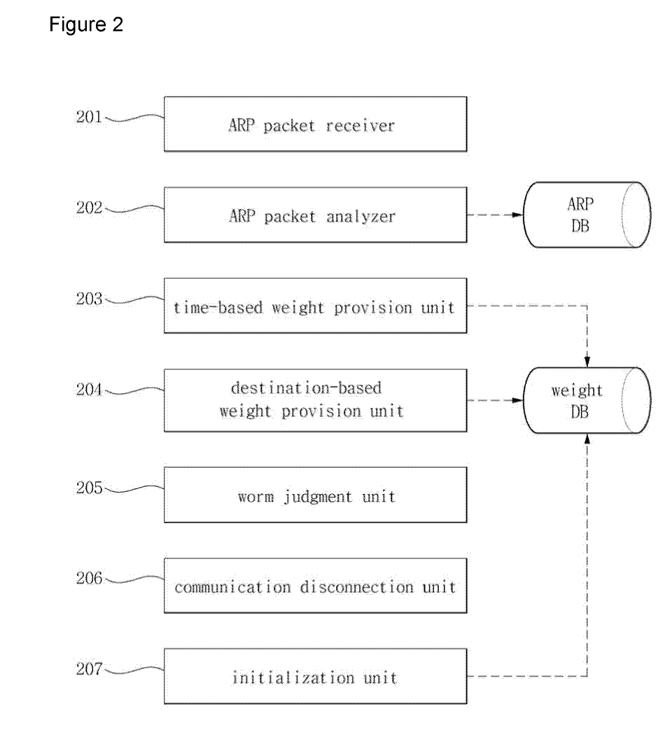

FIG. 2 is a block diagram illustrating a worm detection apparatus using an ARP packet according to the present invention.

The worm detection apparatus using an ARP packet according to the present invention comprises an ARP packet receiver 201, an ARP packet analyzer 202, a time reference weight provision unit 203, a destination reference weight provision unit 204, and a worm judgment unit 205. A communication disconnection unit 206 and an initialization unit 207 may be further provided. The above worm detection apparatus is implemented based on the method of FIG. 1 according to the present invention.

The ARP packet receiver 201 receives an ARP packet through a certain communication network.

The ARP packet analyzer 202 receives the ARP packet from the ARP packet receiver and extracts information concerning a transmission time of the received ARP packet, a transmission computer that transmits the packet, and a destination computer to which the packet is transmitted, and stores the information with respect to the transmission computers.

The time-based weight provision unit 203 receives information concerning a time interval, at which the transmission computer transmits an ARP packet, from the ARP packet analyzer and provides a certain weight of the transmission computer based on the time interval. It is judged that the transmission computer transmits an ARP packet within recent 60 seconds or not. If the ARP packet is transmitted, the weight is set as a result value of “(60−ARP packet transmission time interval)/10”.

The destination reference weight provision unit 204 receives the number of the destination computers, to which the transmission computers transmit the ARP packet, from the ARP packet analyzer and provides a certain weight to the transmission computer in accordance with a certain reference based on the above number. The weight is determined using a result value of “the number of the destination computers of the ARP packet transmitted from the transmission computer/20+1”.

In the case that the destination of the ARP packet received from the transmission computer is duplicate, the number of the destination computers is computed after excluding the duplicate number from the number of the destination computers.

The worm judging unit 205 receives the weight of the transmission computer from the time-based reference weight provision unit and the destination-based weight provision unit. When the weight of the transmission computer exceeds a previously set reference value, the above transmission computer is recognized as a computer infected with worms.

The communication disconnection unit 206 receives information concerning the transmission computer, which is recognized as being infected with the worms from the worm judgment unit, and disconnects the communication of the transmission computer, which is recognized as being infected with the worms.

The initialization unit 207 initializes the value of the weight at certain time intervals.

The method of the present invention may be implemented with a computer program which is executable by the computer, and the computer program may be recorded on a certain recording medium (CD, hard of floppy disk, various memory devices, etc) readable by the computer.

As described above, the worm detection method and apparatus using an ARP packet according to the present invention can be easily implemented, and the driving load of program is less. Since a common characteristic of worm is used, it is possible to easily detect and remove all types of worms with only one time execution on a common computer.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a method for detecting a worm-infected computer among multiple computers connected through a certain communication network, a worm detection method using an ARP packet, comprising:
a step (a) which receives an ARP packet from the communication network;
a step (b) which extracts information concerning a transmission time of the received ARP packet, a transmission computer which transmits the packet, and a destination computer to which the packet is transmitted and stores the information with respect to the transmission computer;
a step (c) in which a certain weight is given to the transmission computer in accordance with a certain reference based on a time interval at which the transmission computer transmits an ARP packet;
a step (d) in which a certain weight is given to the transmission computer in accordance with a certain reference based on the number of the destination computers to which the transmission computer transmits the ARP packet; and
a step (e) in which the transmission computer is recognized as being infected with a worm when a weight of the transmission computer exceeds a previously set certain reference value.

2. The method of claim 1, further comprising a step (f) which disconnects a communication of the computer infected with worms.

3. The method of claim 1, wherein in said step (c), an information concerning an ARP packet transmitted by the transmission computer is read out, and a weight is determined based on “(60−ARP packet transmission time interval)/10” when there are ARP packets which are transmitted within recent 60 seconds.

4. The method of claim 1, wherein in said step (e), the number of the destination computers of the ARP packets transmitted by the transmission computer is read out, and a weight is determined by summing a result value of “number of destination computers/20+1”.

5. The method of claim 4, wherein in said step (e), when the destination computer is duplicate in the number of the destination computers of the ARP packets transmitted by the transmission computer, the number of the destination computers is determined by excluding the duplicate number from the number of the destination computers.

6. The method of claim 1, further comprising a step (g) which initializes the value of the weight with a certain time interval.

7. A recording medium which is readable by a computer having a computer program which can execute a program corresponding to the method of claim 1 on a computer.

8. In an apparatus for detecting a worm-infected computer among multiple computers connected through a certain communication network, a worm detection apparatus using an ARP packet, comprising:
an ARP packet receiver which receives an ARP packet from the communication network;
an ARP packet analyzer which receives an ARP packet from the ARP packet receiver, extracts information concerning a transmission time of the received ARP packet, a transmission computer which transmits the packet, and a destination computer to which the packet is transmitted and stores with respect to the transmission computers;
a time-based weight provision unit which receives an information concerning a time interval, at which the transmission computer transmits an ARP packet, from the ARP packet analyzer and provides a certain weight to the transmission computer in accordance with a certain reference based on the time interval;
a destination-based weight provision unit which receives the number of the destination computers, to which the transmission computer transmits the ARP packet, from the ARP packet analyzer and provides a certain weight to the transmission computer in accordance with a certain reference based on the above number; and
a worm judgment unit which receives a weight of the transmission computer from the time-based weight provision unit and the destination-based weight provision unit and recognizes the transmission computer as being infected with a worm when the weight of the transmission computer exceeds a previously set reference value.

9. The apparatus of claim 8, further comprising a communication disconnection unit which receives an information concerning the worm-infected transmission computer from the worm judgment unit and disconnects a communication of the worm-infected transmission computer.

10. The apparatus of claim 8, wherein said time-based weight provision unit sets a result of “(60−ARP packet transmission time interval)/10” as a weight when the transmission computer transmits an ARP packet within recent 60 seconds by judging whether the transmission computer transmits the same or not.

11. The apparatus of claim 8, wherein said destination-based weight provision unit sets a result of “the number of destination computers of the ARP packets transmitted from the transmission computer/20+1” as a weight.

12. The apparatus of claim 11, wherein said destination-based weight provision unit determines the number of the destination computers by excluding the duplicate number from the number of the destination computers, when the destination of the ARP packet transmitted by the transmission computer is duplicate.

13. The apparatus of claim 8, further comprising an initialization unit which initializes a value of the weight with a certain time interval.
